(19) United States
(12) Patent Application Publication
(10) Pub. No.: US 2014/0053647 A1
(43) Pub. Date: Feb. 27, 2014

(54) MEASURING PROBE FOR SAMPLING MELTED METALS

(71) Applicant: Heraeus Electro-Nite International N.V., Houthalen (BE)

(72) Inventors: Dries BEYENS, Kinrooi (BE); Eric B. BORTELS, Lummen (BE)

(21) Appl. No.: 13/974,435

(22) Filed: Aug. 23, 2013

(30) Foreign Application Priority Data
Aug. 24, 2012 (DE) 10 2012 016 697.4

(51) Int. Cl. G01D 11/24

(52) U.S. Cl. CPC G01D 11/24
USPC 73/431

(57) ABSTRACT

A measuring probe for sampling melted metals, in particular melted steel, includes a measuring head arranged on an immersion end of a support tube. The measuring head includes at least one sample chamber. The sample chamber includes a feed channel having one end which opens into the sample chamber and a second end with a feed opening that projects from the front face of the measuring head facing away from the support tube and is covered by a protective cap. A protective shield is arranged outside of the feed channel upstream of the feed opening in a feed direction at a distance from the feed opening. The protective shield covers the feed opening and the protective shield does not fully surround the feed channel laterally.

### BACKGROUND OF THE INVENTION

The invention relates to a measuring probe for sampling melted metals, in particular in melted steel. The measuring probe has a measuring head arranged on an immersion end of a support tube. The measuring head includes at least one sample chamber, and the sample chamber includes a feed channel whose one end opens into the sample chamber and whose second end includes a feed opening that projects from the front face of the measuring head facing away from the support tube and is covered by a protective cap.

Measuring probes of this type are known, for example, from DE 102010024282 A1. Such probes are intended for performing measurements in a converter. In a converter, a lance is used to blow oxygen into the melted metal. Gas bubbles in the melted metal, for example in melted steel, can interfere significantly with the sampling, since they may ingress or enter into the sample chamber, thereby rendering the samples faulty and difficult to analyze. Similar samplers are known, for example, from DE 102005060493 B3.

It is therefore an object of the present invention to improve on the existing samplers and enable high quality sampling.

### BRIEF SUMMARY OF THE INVENTION

In one embodiment, the object is met through the features of the independent claim. Preferable refinements of embodiments of the present invention are specified in the dependent claims.

In one embodiment, the protective shield is arranged outside of the feed channel upstream of the feed opening in the feed direction at a distance from the feed opening that is covered through a protective cap, the protective shield covers the feed opening, and the protective shield does not fully surround the feed channel laterally. By this arrangement, the gas bubbles that are present in the melted metal and arise, e.g., from oxygen being blown into a converter, do not get situated right in front of the protective cap of the feed opening, and therefore, do not get inside the sample chamber once the protective cap is melted away. Rather, gas bubbles are deflected by the protective shield. Gas being blown into the converter can be implemented, on the one hand, by blowing-in oxygen through a blower lance and, on the other hand, by blowing inert gas through bottom nozzles. It has been evident that the invention allows clearly better, pore-free samples to be obtained.

The protective cap is preferably a conventional protective cap that melts or dissolves when the measuring head is immersed in the melted metal, such that the feed opening for the sample chamber is exposed. Referring to the protective shield, it is preferable, and more preferably essential, for the protective shield to be arranged at a distance from the feed opening having a protective cap. In this context, the protective shield covers the feed opening in such manner that its contour, viewed in an axial direction of the feed channel, surrounds the contour of the feed opening of the feed channel. Expediently, the protective shield will preferably be bracketed on the measuring head.

The bracketing and the shape of the protective shield is preferably designed appropriately such that a lateral opening exists between the feed opening and the protective shield through which the melted metal can ingress or enter into the feed channel. In this context, lateral shall mean deviating from the direction of the axis of the feed channel, preferably approximately radial to the axis.

Preferably, the protective shield is more resistant to melted steel than the protective cap of the feed opening. The greater resistance can be implemented through a more resistant material or through the material being thicker, for example. Preferably, the protective shield is arranged on the front face of the measuring head, whereby it is affixed on the surface of the measuring head or bracketed inside the measuring head itself.

The protective shield can be provided, in particular, as an angled or bent strip-shaped material, since this would enable not only easy production, but also a large opening for the inflowing melted metal. The protective shield can be made of, for example, metal, ceramic or quartz.

It is preferable to have a surface formed between the protective shield and the feed channel that is circumferential on a virtual extension of the feed channel in the direction of the protective shield and that is larger than the surface area of the feed opening, such that the melted metal flowing into the feed channel can reach the feed channel unimpeded and there is no tearing-off, which may be associated with the formation of bubbles. In is preferable, in particular, that the distance between the feed opening and the protective shield in the direction of the feed channel is at least half as large as the diameter of the feed opening.

Preferably, the measuring probe is provided appropriately such that the front face of the measuring head having the feed channel and the protective shield is covered on one side by a slag cap. Accordingly, the protective shield is arranged between the slag cap and the protective cap of the feed channel. The slag cap protects the front face of the measuring head during transport of the measuring probe and during immersion through the slag, such that the slag cannot damage the protective shield or the feed channel.

Preferably, the slag cap itself dissolves, at the latest, upon the measuring head penetrating into the melted metal and then exposes the front face of the measuring head, which has the feed channel attached to it, to the melted metal, such that the protective cap of the feed channel dissolves and the melted metal can ingress or enter into the sample chamber. It is advantageous to have at least one sensor for measuring the temperature or any other parameter of the melted metal arranged on the measuring head. Preferably, the sensor is also arranged on the front face of the measuring head and is covered through the slag cap.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

An exemplary embodiment of the invention shall be illustrated in more detail in the following based on the drawings. In the drawings:

FIG. 1 shows the application of the measuring probe in a converter according to one embodiment of the present invention;

FIG. 2 shows a schematic view of the measuring head of the measuring probe according to an embodiment of the present invention; and

FIG. 3 shows a sectional view of the measuring probe.

### DETAILED DESCRIPTION OF THE INVENTION

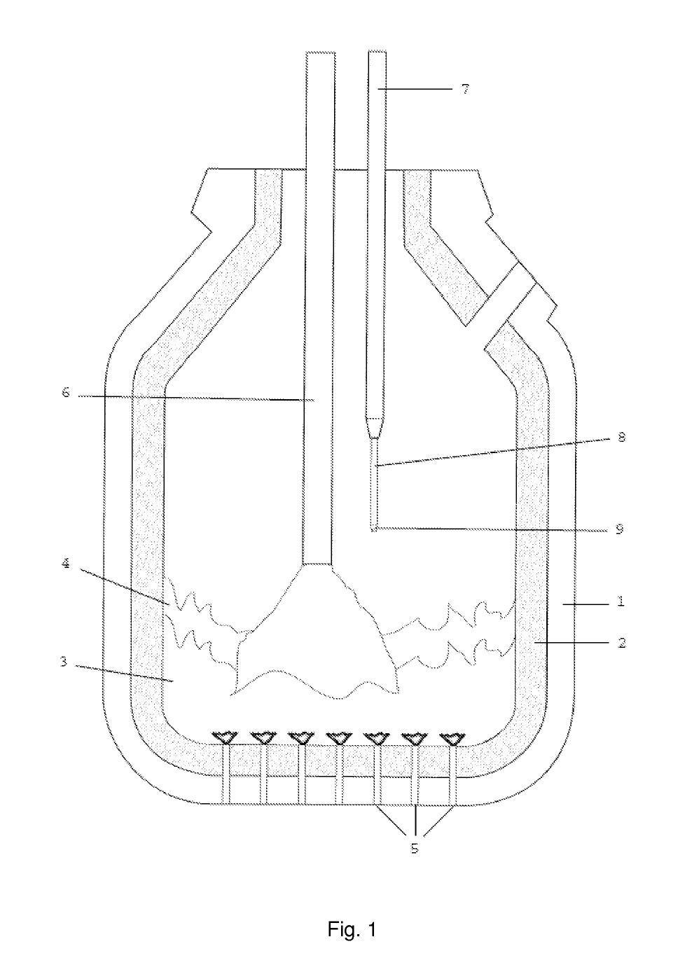

FIG. 1 shows a converter 1 having a lining 2. The converter 1 contains melted steel 3 on which rests a slag layer 4. For steel production, argon is blown-in through the bottom of the converter 1 through floor nozzles 5 into the melted metal. Oxygen is blown-in from above by a blower lance 6. Aside from the blower lance 6, a so-called sub-lance 7, which has a measuring probe 8 having a measuring head 9 arranged on its immersion end, is being introduced into the converter.

The measuring and/or sampling process takes place while oxygen is being blown-in, usually approximately 2 minutes before the end of the oxygen being blown-in. The temperature is being measured in this context and a sample is taken for determination of, for example, the carbon content of the melted steel. The results of the measurements can be used to correct the blowing model in order to be able to change the quality of the melted steel.

A second measurement can be performed after blowing-in the oxygen. In this context, usually not only the temperature, but also the active oxygen content is measured in the melted steel and a sample for determination of the final composition of the steel in the laboratory is taken. The oxygen content can be used to determine, within a few seconds, the current carbon content in the steel. Moreover, the requisite amounts of a deoxidation agent (e.g., aluminium) can be pre-calculated.

Aside from the above-described effect of blowing-in oxygen and the ensuing formation of gas bubbles, which may impede or interfere with the sampling, blowing-in gas through the bottom nozzles 5 might also have an interfering effect on the sampling, since this gas rises in the direction of the immersed measuring probe, such that it exactly meets the measuring probe and the feed opening, unless these are protected. Moreover, the activity of the blower lance may cause a small amount of slag to get into the melted steel as well. The slag can also interfere with the sampling.

The design of the measuring probe according to an embodiment of the present invention provides a remedy in this respect, as the protective shield deflects gas bubbles and slag particles away from the feed opening.

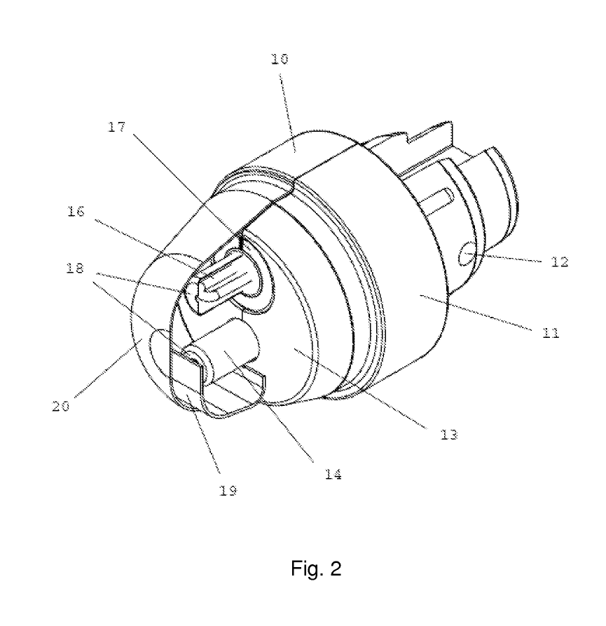

FIG. 2 shows the measuring head according to an embodiment of the present invention. The base body of the measuring head includes two parts 10, 11 which are made of foundry sand and which include, on the end facing away from the immersion end, a bore hole 12 through which a screw extends to fix the two parts 10, 11 to each other. The two-part design simplifies the assembly of the sample chamber and sensors.

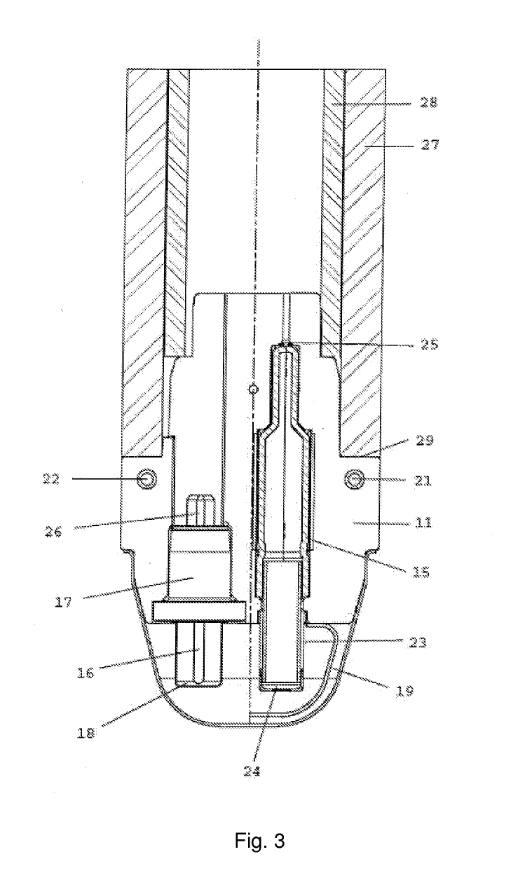

A feed channel 14 extends on the front face 13 of the measuring head from the inside of the measuring head to the outside. On the inside of the measuring head, the feed channel is connected to a sample chamber 15 (see FIG. 3). A thermocouple 16 is also arranged on the front face 13. The thermocouple 16 is affixed in a thermocouple insert 17. Both the thermocouple 16 and the feed channel 14 are covered through protective caps 18.

A protective shield 19 is arranged adjacent to the feed channel 14 for the sample chamber 15. The protective shield 19 is formed by a bent strip of sheet metal that is affixed to the front face 13 of the measuring head, extends alongside the feed channel, and is bent upstream of the feed opening of the feed channel, such that it covers the feed opening of the feed channel 14. The distance between the feed opening and the protective shield 19 is a little more than half as large as the diameter of the feed opening. The feed opening itself is not shown in FIG. 2, since it is covered by a protective cap 18.

A slag cap 20 is arranged on the front face 13 of the measuring head and surrounds and preferably fully covers the front face 13, including the elements arranged on the front face; i.e., of the thermocouple 16 and of the feed channel 14 including the respective protective caps 18 and including the protective shield 19. As a result, the protective shield 19 is arranged between the protective cap 18 of the feed channel 14 and the slag cap 20.

The inside of the measuring head is shown in FIG. 3 in a sectional view and/or in the view onto the sectioned part of a part 11 of the measuring head. Both parts 10, 11 of the measuring head are adjusted with respect to each other by studs 21 engaging depressions 22 of the respective other part. The sample chamber 15 shown in FIG. 3 is a flat sample chamber which, as is common, is designed to have two parts that differ in thickness.

The feed channel is formed by a quartz tube 23 whose feed opening 24 is closed by a protective cap 18. The end of the sample chamber 15 facing away from the feed channel includes a de-gassing opening 25 through which the gas present in the sample chamber 15 exits when the melted metal flows in. FIG. 3 does not show the signal leads that are arranged on the contact part 26 of the thermocouple insert 17 and are guided out through the rear end of the measuring head.

The measuring head is plugged onto cardboard tubes 27, 28 and affixed to the external cardboard tube by a refractory adhesive 29. The combination of the two cardboard tubes 27, 28 serves to stabilize the fixation of the measuring head.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A measuring probe for sampling melted metals comprising:
a measuring head (9) arranged on an immersion end of a support tube (27) and having at least one sample chamber (15), the sample chamber (15) including a feed channel (14) having a first end which opens into the sample chamber (15) and a second end with a feed opening (24) that projects from a front face of the measuring head (9) facing away from the support tube (27) and is covered by a protective cap (18); and
a protective shield (19) arranged outside of the feed channel (14) upstream of the feed opening (24) in a feed direction at a distance from the feed opening (24),
wherein the protective shield (19) covers the feed opening (24) and does not fully surround the feed channel (14) laterally.

2. The measuring probe according to claim 1, wherein the melted metals comprise melted steel.

3. The measuring probe according to claim 1, wherein the protective shield (19) is more resistant to the melted metals than the protective cap (18) of the feed opening (24).

4. The measuring probe according to claim 1, wherein the protective shield (19) is arranged on the front face of the measuring head (9).

5. The measuring probe according to claim 1, wherein the protective shield (19) is provided as an angled strip-shaped material.

6. The measuring probe according to claim 1, wherein the protective shield (19) is made of a material selected from the group consisting of metal, ceramic and quartz.

7. The measuring probe according to claim 1, wherein a surface is formed between protective shield (19) and feed channel (14) that is circumferential on a virtual extension of the feed channel (14) in a direction of the protective shield (19) and is larger than a surface area of the feed opening (24).

8. The measuring probe according to claim 1, wherein the distance between feed opening (24) and the protective shield (19) in a direction of the feed channel (14) is at least half as large as the diameter of the feed opening (24).

9. The measuring probe according to claim 1, wherein the front face of the measuring head (9) having the feed channel (14) and the protective shield (19) is covered by a slag cap (20).

10. The measuring probe according to claim 1, wherein at least one sensor (16) for measuring the temperature or any other parameter of the melted metals is arranged on the measuring head (9).
